(19) United States
(12) Patent Application Publication
(10) Pub. No.: US 2026/0146503 A1
(43) Pub. Date: May 28, 2026

(54) CONTAINMENT SYSTEM FOR PARKING SPACE FOR VEHICLE AND METHOD THEREOF

(71) Applicant: Ronald M. Butler, West Bloomfield, MI (US)

(72) Inventor: Ronald M. Butler, West Bloomfield, MI (US)

(21) Appl. No.: 19/401,509

(22) Filed: Nov. 26, 2025

Related U.S. Application Data
(60) Provisional application No. 63/725,731, filed on Nov. 27, 2024.

(51) Int. Cl. E06B 9/68; B60J 11/04

(52) U.S. Cl. CPC E06B 9/68; B60J 11/04; E06B 2009/6818

(57) ABSTRACT

A containment system for a parking space for a vehicle is disclosed. The containment system can include a deployment module, a detection module in communication with the deployment module, and a barrier operatively coupled to the deployment module. The deployment module can mount proximate to the parking space. The detection module can detect a thermal event associated with the vehicle or the surrounding environment. The barrier can deploy relative to a portion of the parking space in response to detection of the thermal event. Upon deployment, the barrier can isolate, shield, or otherwise contain conditions produced during the thermal event. The containment system can be adapted for use with a variety of parking arrangements and can operate automatically without user intervention. The containment system can militate against hazards associated with thermal events, including thermal events involving vehicles equipped with battery systems.

### CROSS-REFERENCE TO RELATED APPLICATIONS

This application claims the benefit of U.S. Provisional Application No. 63/725,731, filed on Nov. 27, 2024. The entire disclosure of the above application is incorporated herein by reference.

### FIELD

The present technology relates to containment systems, and, more particularly, to a containment system for a parking space for a vehicle.

### INTRODUCTION

This section provides background information related to the present disclosure which is not necessarily prior art.

Electric vehicles are becoming increasingly prevalent as society continues to explore and adopt alternative energy sources for powering various modes of transportation. The growing availability of electric vehicles, combined with advancements in battery technology and supporting infrastructure, has led to a corresponding increase in the number of electric vehicles parked in residential, commercial, and public facilities. Many of these vehicles rely on high-energy battery systems that, while generally safe, can present thermal risks under certain conditions.

Thermal events involving high-capacity battery systems may propagate rapidly and generate high temperatures, toxic gases, or other hazardous byproducts. When such events occur in confined or semi-confined environments such as parking garages, enclosed parking structures, or areas where vehicles are parked in close proximity to one another, there may be an increased risk of damage to adjacent property, nearby vehicles, or structural components of the facility. In addition, thermal events can be difficult to suppress and may require significant time and resources for containment.

As the prevalence of electric vehicles continues to rise, there is an increasing need for systems and methods that can detect, contain, and mitigate the effects of thermal events in or around parked vehicles. Existing devices and systems do not provide localized, rapidly deployable containment and may be insufficient for addressing hazards associated with high-energy battery systems.

Accordingly, there is a need for a containment system for a parking space for a vehicle that can be integrated with parking spaces and that is capable of automatically responding to and managing thermal events in an effective and controlled manner.

### SUMMARY

In concordance with the instant disclosure, a containment system for a parking space for a vehicle, has surprisingly been discovered. The present technology includes articles of manufacture, systems, and processes that relate to a containment system for a parking space for a vehicle.

In certain embodiments, a containment system for a parking space for a vehicle is provided. The containment system can include a deployment module, a detection module in communication with the deployment module, and a barrier operatively coupled to the deployment module. The deployment module can mount proximate to the parking space. The detection module can detect a thermal event associated with the vehicle or the surrounding environment. The barrier can deploy relative to a portion of the parking space in response to detection of the thermal event. Deployment of the barrier can limit the propagation of heat, flame, or gases generated during the event and can militate against collateral damage or escalation within the surrounding environment. The containment system can be adapted for use with a variety of parking arrangements and can operate automatically without user intervention.

In certain embodiments, a parking space for a vehicle is provided. The parking space can include the vehicle disposed within the parking space and a containment system as described herein installed above the parking space. The containment system can be positioned to extend over the vehicle and the parking space, allowing for deployment of a barrier in response to a thermal event.

In certain embodiments, a method of containing a vehicle in a parking space during a thermal event is provided. The method can include providing a containment system as described herein positioned proximate to the parking space. The method can include detecting a thermal event associated with the vehicle or the surrounding environment. In response to detection of the thermal event, a barrier can be deployed to extend over or around the vehicle, providing containment, shielding, or isolation from conditions produced during the thermal event.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating a containment system for a parking space for a vehicle, according to an embodiment of the present disclosure;

FIG. 2 is a top perspective view of a containment system for a parking space for a vehicle, according to an embodiment of the present disclosure;

FIG. 3 is a left-side elevational view of the containment system, according to the embodiment shown in FIG. 1;

FIG. 4 is a top perspective view of the containment system, according to the embodiment shown in FIG. 1;

FIG. 5 is a cross-sectional view of the containment system, according to the embodiment shown in FIG. 1;

FIG. 6A is a is a top perspective view of a containment system in a stored configuration, according to an embodiment of the present disclosure;

FIG. 6B is a top perspective view of the containment system deploying a barrier in response to a thermal event, according to the embodiment shown in FIG. 5A;

FIG. 6C is a top perspective view of the containment system in a deployed configuration, according to the embodiment shown in FIG. 5A; and

FIGS. 7 and 8 are charts illustrating a method of containing a vehicle in a parking space during a thermal event, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides a containment system for a parking space for a vehicle, including an electric vehicle, to address hazards associated with thermal events that can occur while the vehicle is parked. The containment system can incorporate one or more detection elements configured to sense elevated temperatures or related indicators of a thermal event and can automatically deploy a barrier relative to the parking space. Deployment of the barrier can limit the propagation of excessive heat, flame, smoke, or gases generated during the thermal event and can militate against damage to the vehicle and collateral damage or escalation to or within the surrounding environment. The containment system can be used in a variety of environments, including high-density electric vehicle storage, manufacturing and assembly facilities, recycling and dismantling operations, warehousing and logistics such as distribution centers, micro-mobility garages, data centers and telecommunications facilities, military and defense installations, research and testing laboratories, mining operations and tunnels, and aviation or marine environments such as hangars and charging areas.

A thermal event can include any occurrence in which temperature changes play a significant role in causing, signaling, or accompanying a physical, chemical, or mechanical process. A thermal event can include an increase in temperature associated with overheating of vehicle components, degradation or failure of a battery system, combustion of materials in or around the vehicle, or abnormal thermal behavior originating from electrical, mechanical, or chemical sources. A thermal event can further include conditions such as thermal runaway, localized heating, smoke generation, gas release, or ignition of surrounding materials. The containment system can be configured so that a wide range of thermal conditions or indicators can be sensed, evaluated, and used as triggers for deployment of protective features.

Activation of the containment system can be based on one or more conditions exceeding predetermined or nominal thresholds. A temperature condition can activate the system when a sensed temperature rises above a baseline or nominal value associated with normal operation of the vehicle or surrounding environment. Similarly, concentrations of smoke or gases can activate the system when such concentrations exceed nominal background levels that are indicative of ordinary ambient conditions. The containment system can be configured so that activation occurs when any selected combination of heat, smoke, or gas thresholds is surpassed, thereby permitting deployment of the barrier in response to conditions that suggest the onset or progression of a thermal event.

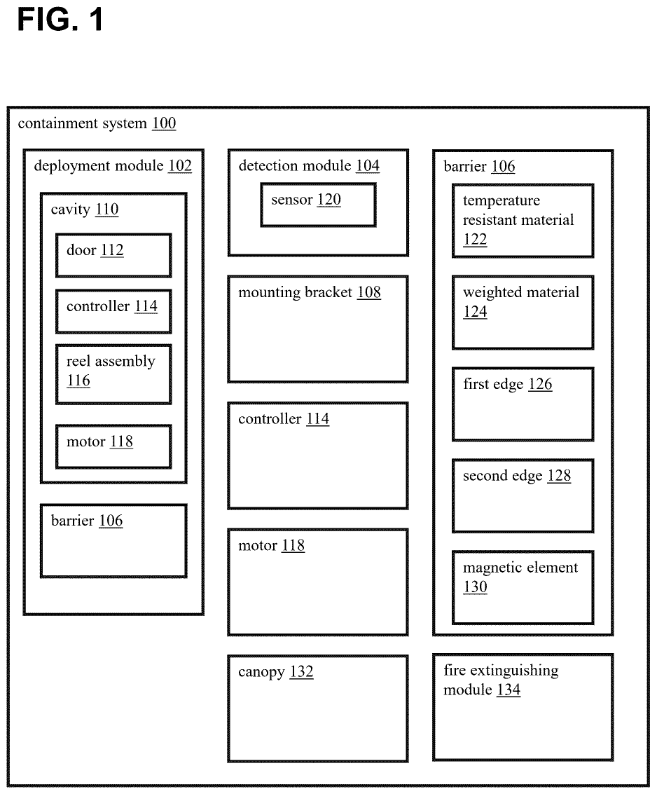

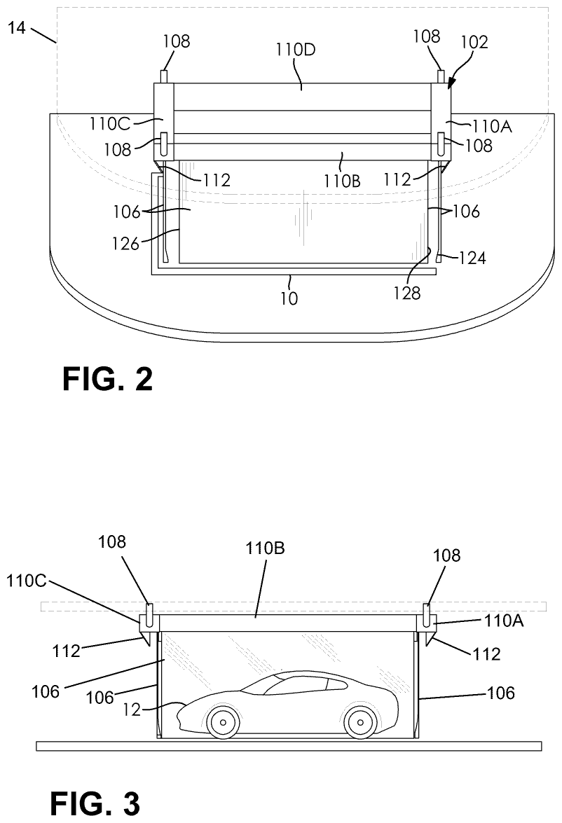

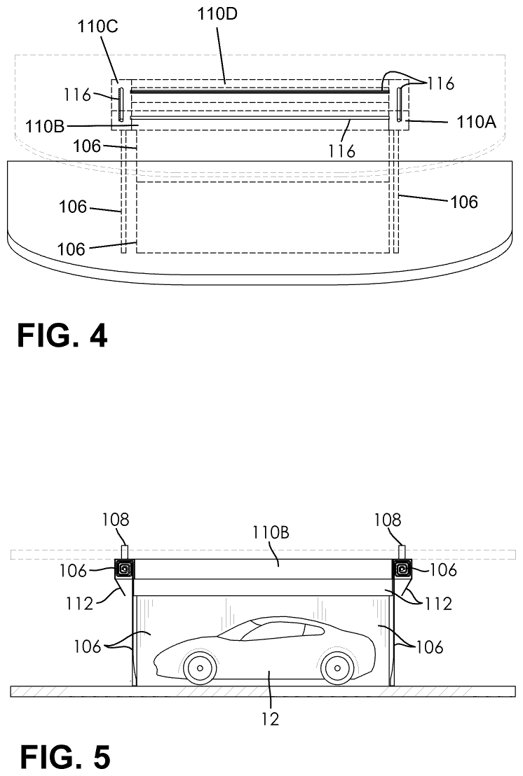

With reference to FIGS. 1-5, in certain embodiments, a containment system 100 for a parking space 10 for a vehicle 12 is provided. The containment system 100 can be arranged to function in cooperation with structures, fixtures, or surfaces that define the parking space 10. The containment system 100 can be used with a variety of vehicles, including vehicles powered by combustion engines, hybrid vehicles, and electric vehicles. The containment system 100 can be configured to provide a protective environment around the vehicle 12 in circumstances in which a thermal event can be detected or anticipated. The containment system 100 can be installed proximate to the parking space 10 with the vehicle 12 disposed in the parking space 10.

In certain embodiments, the parking space 10 can be defined as an area, surface, or zone configured to receive and support a vehicle 12. The parking space 10 can include a marked or designated area on a ground surface, a raised platform, a garage bay, a designated zone within a parking structure, or other configured location suitable for positioning the vehicle 12. The parking space 10 can be bounded by structures, fixtures, curbs, lines, or other physical or visual markers that define the limits of the space. The parking space 10 can be adapted to accommodate vehicles of various sizes and types, including motorcycles, automobiles, electric vehicles, hybrid vehicles, and commercial vehicles.

The containment system 100 can include a deployment module 102 configured to mount proximate to the parking space 10. The deployment module 102 can be sized and shaped to be positioned near, against, or adjoining a boundary surface associated with the parking space 10. The deployment module 102 can include materials suitable for supporting structural loads imposed by components housed within or attached to it. The deployment module 102 can allow controlled movement, storage, or release of other elements of the containment system 100.

The containment system 100 can include a detection module 104 in communication with the deployment module 102. The detection module 104 can transmit signals, data, or alerts to the deployment module 102 under conditions in which a thermal event can occur. The detection module 104 can be located adjacent the deployment module 102 or can be spaced apart depending on design considerations for the containment system 100. The detection module 104 can be arranged so that detection information can be delivered reliably to initiate deployment of elements associated with the containment system 100.

A barrier 106 can be operatively coupled to the deployment module 102 of the containment system 100. The barrier 106 can be arranged so that it can move relative to the parking space 10 in a controlled manner. The barrier 106 can be configured to transition from a first position (a stored position) in which the barrier 106 remains compact and enclosed within the deployment module 102 to a second position (a deployed position) in which the barrier 106 extends relative to the parking space 10 when the detection module 104 detects the thermal event. The barrier 106 can provide enclosure, shielding, or separation between the vehicle 12 and its surrounding environment during conditions associated with the thermal event. It should be understood that the portion of the parking space covered by the barrier 106 can include an entirety of the parking space 10.

In certain embodiments, the barrier 106 can include a curtain, a sheet, a plank, a wall, and combinations thereof. The barrier 106 can be formed from flexible or rigid constructions so that the barrier 106 can be rolled, folded, slid, or otherwise moved into a stored configuration and can be unrolled, unfolded, slid, or otherwise moved into a deployed configuration. The barrier 106 can include a fire protective or fire-retardant material that can include, for example, fiberglass, carbonized fiber fabric, ceramic fiber, an aramid fiber composite, a metallized fabric, and combinations thereof, and the barrier 106 can include layered constructions or coatings to enhance thermal resistance.

In certain embodiments, the deployment module 102 of the containment system 100 can be configured to mount adjacent the parking space 10 in a variety of positions. The deployment module 102 can be mounted on one or more sides of the parking space 10 such that the deployment module 102 can deploy the barrier 106 into the parking space 10 when needed. The deployment module 102 can additionally be mounted above the parking space 10 to allow downward deployment of the barrier 106. The deployment module 102 can further be mounted below the parking space to allow upward or lateral deployment depending on structural requirements.

The deployment module 102 of the containment system 100 can include a mounting bracket 108 configured to mount the deployment module 102 adjacent to the parking space. The mounting bracket 108 can provide physical support and stability for the deployment module 102 when secured to a wall, ceiling 14, floor, or other structure. The mounting bracket 108 can be shaped to receive and retain a portion of the deployment module 102 using fasteners or other attachment features. The mounting bracket 108 can allow the deployment module to remain in a fixed, operable location relative to the parking space 10.

In certain embodiments, the deployment module 102 of the containment system 100 can include a cavity 110 from which the barrier 106 can be deployed. The cavity 110 can be dimensioned to receive the barrier 106 in a compact state when the barrier 106 is not deployed. The cavity 110 can be shaped to guide the movement of the barrier 106 as it transitions from a stored condition to a deployed condition. The cavity 110 can also be positioned so that the barrier 106 can extend outward relative to the parking space 10.

In certain embodiments, the cavity 110 can include at least a portion of the barrier 106. The cavity can receive the barrier 106 in a rolled, folded, stacked, or compressed arrangement so that the barrier 106 can be stored in a compact configuration when not deployed. The cavity can define an interior volume that can protect the barrier 106 from environmental exposure, such as moisture, debris, or ultraviolet light. At least a portion of the barrier 106 can remain within the cavity even when the barrier 106 is partially or fully deployed, allowing the barrier 106 to be guided, tensioned, or supported during extension. The cavity can be shaped, reinforced, or sized so that the portion of the barrier 106 stored therein can be maintained in an accessible orientation for reliable deployment in response to a thermal event.

In certain embodiments, the cavity 110 of the containment system 100 can include a door 112 configured to move between an open position and a closed position. The door 112 can enclose the cavity 110 when the barrier 106 is stored, thereby shielding the barrier 106 from dust, debris, or inadvertent contact. The door 112 can move to an open position to allow the barrier 106 to extend outward from the cavity 110. The door 112 can be arranged to return to a closed position when the barrier is retracted or otherwise no longer extending outward.

The door 112 of the cavity 110 for containment system 100 can include a sliding door, a hinged door, or a multi-panel door. A sliding door can move laterally along a track to expose or cover the cavity 110. A hinged door can pivot outward or inward relative to an attachment point on the deployment module 102. A multi-panel door can fold or collapse in sections to open the cavity 110 while minimizing required clearance space.

In certain embodiments, the cavity 110 of the deployment module 102 of containment system 100 can include a plurality of cavities 110a, 110b, 110c, 110d. The plurality of cavities 110a, 110b, 110c, 110d can be arranged so that the barrier 106 can deploy from one of the cavities of the plurality of cavities 110a, 110b, 110c, 110d when needed. The plurality of cavities 110a, 110b, 110c, 110d can allow multi-directional or multi-sided deployment relative to the parking space 10.

It should be understood that the plurality of cavities 110a, 110b, 110c, 110d can be disposed around a perimeter of the parking space. The plurality of cavities 110a, 110b, 110c, 110d can be positioned so that the barrier 106 can extend and enclose the vehicle 12 from multiple directions. For example, the plurality of cavities 110a, 110b, 110c, 110d can be positioned along one or more sides of the parking space 10 to provide comprehensive coverage. The number of cavities can be adjusted depending on the size of the parking space 10 or the dimensions of the vehicle 12. Each cavity 110 can house a separate barrier 106 configured to deploy in a coordinated manner with other barriers 106.

In certain embodiments, each cavity 110a, 110b, 110c, 110d of the containment system 100 can include a single barrier 106. The barrier 106 can be fully contained within the cavity 110 when in a stored configuration, allowing for organized and independent deployment of each barrier 106. Each cavity can be configured to support the barrier 106 during retraction and extension, ensuring smooth movement and alignment when deployed. The arrangement of a single barrier 106 per cavity 110 can allow multiple cavities to be positioned around the parking space 10, enabling coordinated deployment to cover portions or the entirety of the parking space 10.

In certain embodiments, the deployment module 102 of containment system 100 can include an actuator configured to move the door 1120 between the open position and the closed position. The actuator can provide controlled motion that assists in reliably positioning the door 112 during operation. The actuator can be positioned within or adjacent to the cavity 110 to drive the movement of the door 112 without interfering with the barrier 106.

The actuator of the containment system 100 can include an electric motor, a hydraulic piston, a pneumatic piston, an electromagnetic solenoids, and combinations thereof. An electric motor can provide rotational or linear motion suitable for repositioning the door 112 in response to signals from the detection module. A hydraulic piston can offer controlled linear displacement using fluid pressure to open or close the door 112. A pneumatic piston or electromagnetic solenoid can similarly generate motion suitable for repositioning the door 112 while remaining compatible with various structural arrangements of the deployment module 102.

In certain embodiments, the deployment module 102 of the containment system 100 can include a controller 114 configured to be in communication with the detection module 104. The controller 114 can receive sensor information and interpret whether conditions associated with a thermal event are present. The controller 114 can generate signals to actuate movement of the door 112, the barrier 106, or other components contained within the deployment module 102. The controller 114 can be programmed or otherwise configured to coordinate timing, speed, or sequence of operations relating to deployment of the barrier 106.

In certain embodiments, the deployment module 102 of the containment system 100 can include a reel assembly 116 configured to wind and unwind the barrier 106 between a first position and a second position. The reel assembly 116 can support the barrier 106 in a rolled or folded configuration when the barrier 106 is stored. The reel assembly 116 can be located within the cavity 110 or positioned adjacent to the cavity 110 depending on design considerations.

The reel assembly 116 can include a torsion spring, a constant-force spring, a multi-stage spring, and combinations thereof. A torsion spring can store rotational energy and release it to assist in rotating the reel assembly 116. A constant-force spring can apply substantially uniform tension during movement of the barrier 106. A multi-stage spring can offer varying resistances at different points of travel to accommodate different deployment dynamics of the barrier 106.

In certain embodiments, the deployment module 102 can include a motor 118 configured to rotate the reel assembly 116. The motor 118 can apply torque needed to wind or unwind the barrier 106 during movement between positions. The motor 118 can be controlled by the controller 114 in response to signals received from the detection module 104. The motor 118 can be configured to operate at variable speeds depending on factors such as barrier weight or deployment requirements. The motor can include an electric motor, a servo motor or a variable-speed motor. The variable-speed motor can adjust torque or speed delivered during winding or unwinding operations. A servo motor can provide precise positional control useful for ensuring that the barrier 106 aligns properly relative to the parking space 10.

In certain embodiments, the detection module 104 of containment system 100 can include a sensor 120 configured to detect the thermal event. The sensor 120 can be positioned within the detection module 104 or proximate to the deployment module 102 to sense conditions. The sensor 120 can monitor variables that indicate elevated temperatures or other signs of a potential thermal event. Sensor information can be communicated to the deployment module 102 for initiating deployment of the barrier 106. The sensor 120 can include a temperature sensor, a pressure sensor, a gas sensor, a smoke detector, a humidity sensor, a tilt sensor, and combinations thereof. Each type of sensor 120 can provide specific information about the conditions within or around the parking space 10. The variety of sensors can allow the containment system 100 to respond to multiple indications of a thermal event. Sensors can operate individually or in combination to provide reliable detection for deployment of the barrier 106.

In certain embodiments, the temperature sensor can include an infrared thermometer, an optical pyrometer, a thermal imaging sensor, and combinations thereof. The temperature sensor can detect heat levels, temperature gradients, or hotspots associated with the thermal event. The sensor can operate continuously or intermittently. Information from the temperature sensor can be provided to the controller 114 to initiate deployment of the barrier 106 when pre-determined thresholds are meant or exceeded.

In certain embodiments, the pressure sensor can include a piezoelectric sensor, a differential pressure sensor, a barometric sensor, and combinations thereof. The pressure sensor can detect changes in air pressure that may be associated with the thermal event. Pressure information can be communicated to the controller 114 to initiate deployment of the barrier 106 when pre-determined thresholds are meant or exceeded.

In certain embodiments, the gas sensor can include a catalytic sensor, an electrochemical sensor, an infrared sensor, a nondispersive infrared sensor, a photoionization sensor, a semiconductor sensor, a photoacoustic sensor, a tunable diode laser absorption spectroscopy sensor, and combinations thereof. The gas sensor can detect combustible or hazardous gases generated during the thermal event. Gas information can be communicated to the controller 114 to initiate deployment of the barrier 106 when pre-determined thresholds are meant or exceeded.

In certain embodiments, the smoke detector can include a photoelectric smoke detector, an ionization smoke detector, and combinations thereof. The smoke detector can identify particulate matter or combustion byproducts indicative of the thermal event. Smoke information can be communicated to the controller 114 to initiate deployment of the barrier 106 when pre-determined thresholds are meant or exceeded.

In certain embodiments, the humidity sensor can include a capacitive humidity sensor, a resistive humidity sensor, a thermal conductivity humidity sensor, an optical humidity sensor, and combinations thereof. Humidity readings can be used to assess environmental conditions that may precede or accompany the thermal event. Humidity information can be communicated to the controller 114 to initiate deployment of the barrier 106 when pre-determined thresholds are meant or exceeded.

In certain embodiments, the tilt sensor can include an accelerometer-based sensor, a gyroscope-based sensor, a ball-based or pendulum-based sensor, a liquid-based sensor, and combinations thereof. The tilt sensor can detect orientation changes of the vehicle or parking surface that may indicate abnormal events. Tilt information can be communicated to the controller 114 to initiate deployment of the barrier 106 when pre-determined thresholds are meant or exceeded.

In certain embodiments, the sensor 120 can include a container sensor device for detecting a thermal event, including heat, heat-vent rise, smoke, humidity, pressure, and tilt conditions, within a container.

The present application further incorporates by reference herein the entirety of U.S. patent application Ser. No. 18/933,347 titled “CONTAINER SENSOR ASSEMBLY, SYSTEM, AND METHOD” filed on Oct. 31, 2024. U.S. patent application Ser. No. 18/933,347, which discloses a container sensor device for detecting a thermal event, including heat, heat-vent rise, smoke, humidity, pressure, and tilt conditions, within a container. The disclosed sensor device and its thermal event detection capabilities are particularly relevant to the detection module technology of the present application for identifying and containing thermal events in parked vehicles.

In certain embodiments, the barrier 106 can include a temperature resistant material 122. The temperature resistant material 122 can be selected to withstand elevated temperatures associated with thermal events without significant deformation or degradation. The temperature resistant material 122 can allow the barrier 106 to maintain structural integrity while enclosing the vehicle 12. Suitable temperature resistant material can provide both thermal insulation and resistance to direct heat exposure.

The temperature resistant material 122 can include fiberglass, carbonized fiber fabric, ceramic containing materials including, ceramic fiber, aramid fiber composite, metallized fabric, concrete containing materials, glass containing materials, including glass-magnesium containing components, silica containing materials, and combinations thereof. These materials can be selected based on their thermal conductivity, strength, flexibility, or durability. The materials can be layered or combined to enhance performance under various thermal conditions experienced during a thermal event.

In certain embodiments, the temperature resistant material 122 can include a temperature resistant material for containing thermal events, including a multi-layer temperature resistant material capable of withstanding temperatures up to 1000° C.

The present application further incorporates by reference herein the entirety of U.S. patent application Ser. No. 18/933,055 titled “SMART FIRE BLANKET DEVICE, SYSTEM, AND METHOD” filed on Oct. 31, 2024. U.S. patent application Ser. No. 18/933,055, which discloses a temperature resistant material for containing thermal events, including a multi-layer temperature resistant material capable of withstanding temperatures up to 1000° C. The disclosed temperature resistant material is particularly relevant to the temperature resistant material of the present application for containing thermal events in parked electric vehicles.

In certain embodiments, the barrier 106 can include a weighted material 124 to enhance deployment stability. The weighted material 124 can be disposed along a portion of the barrier 106 configured to contact the parking space 10 adjacent to the vehicle 12 when deployed. The weighted material 124 can assist the barrier 106 in reaching the deployed position. The weighted material 124 can also help maintain contact with the parking space to reduce gaps.

In certain embodiments, the barrier 106 can include a first edge 126 and a second edge 128 disposed opposite each other. The first edge 126 and the second edge 128 can be oriented substantially perpendicular to a surface of the parking space 10. The first edge 126 and the second edge 128 can provide structural alignment for coupling with an adjacent barrier 106.

Each of the first edge 126 and second edge 128 of the barrier 106 can include a magnetic element 130 configured to couple with the adjacent barrier 106 when the barrier 106 is deployed. The magnetic elements 130 can facilitate continuous alignment and connection between multiple barriers. The configuration can allow barriers 106 to form a contiguous enclosure around the vehicle 12.

In certain embodiments, the containment system 100 can include a canopy 132 configured to provide overhead coverage. The canopy 132 can include a temperature resistant material, such as fiberglass, carbonized fiber fabric, ceramic fiber, aramid fiber composite, metallized fabric, and combinations thereof. The canopy 132, together with the barrier 106, and the deployment module 102, can provide comprehensive protection and containment in response to the thermal event.

In certain embodiments, the containment system 100 can include a fire extinguishing module 134. The fire extinguishing module 134 can be configured to release a suppressant in response to detection of a thermal event or elevated temperatures by the detection module 104. The suppressant can include, for example, water, foam, aerosol, dry chemical, or gaseous extinguishing agents, and combinations thereof, and can be directed to the vehicle 12, the parking space 10, or the surrounding environment as needed. The fire extinguishing module 134 can be controlled by the deployment module 104 or a separate controller and can be coordinated with barrier 106 deployment to enhance containment, limit flame propagation, and militate against damage to the vehicle 12 or collateral escalation of the thermal event.

In certain embodiments, fire-extinguishing module 134 can include a FirePro FP-3000 condensed-aerosol generator, a product marketed by FirePro Systems Ltd. The FP-3000 unit contains approximately 3,000 g of a proprietary FirePro condensed-aerosol (FPC) compound that, when activated, rapidly produces a dense aerosol that chemically interrupts the combustion reaction rather than relying on oxygen displacement.

In certain embodiments, each containment system 100 associated with an individual parking space 10 can be configured to communicate with one or more additional containment systems installed within the same facility. This arrangement can permit multiple deployments to be linked or synchronized such that activation of a barrier in response to a thermal event at one parking space can cause barriers at adjacent or nearby parking spaces to deploy as well. Such coordinated deployment can provide an added level of protection by forming a broader containment zone around the affected area and by reducing the potential for propagation of heat, smoke, or gases between vehicles. After a deployment event, the barriers can be retracted or re-rolled into their respective cavities if they have not been damaged, thereby allowing the containment systems to be restored to a ready state for subsequent use.

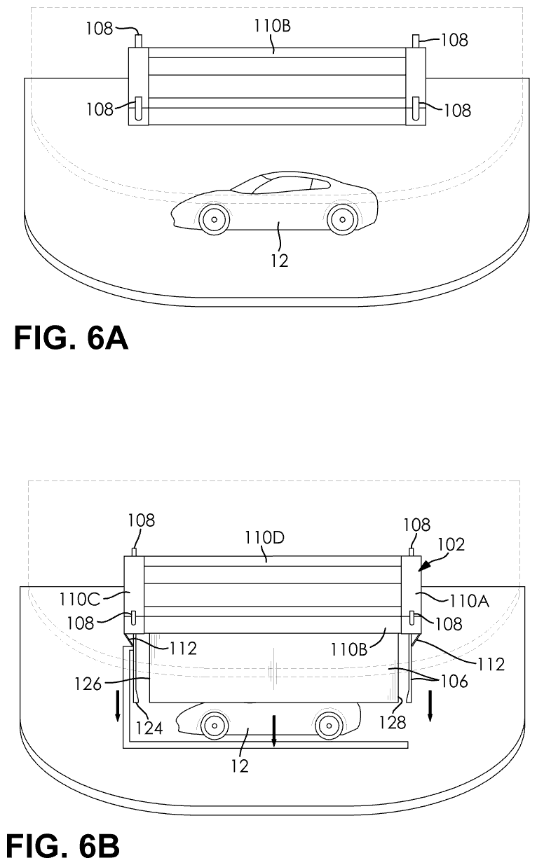

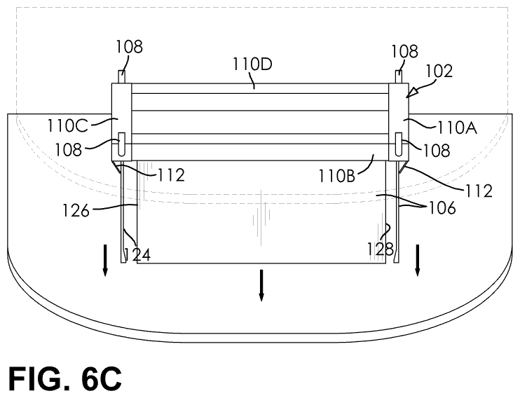

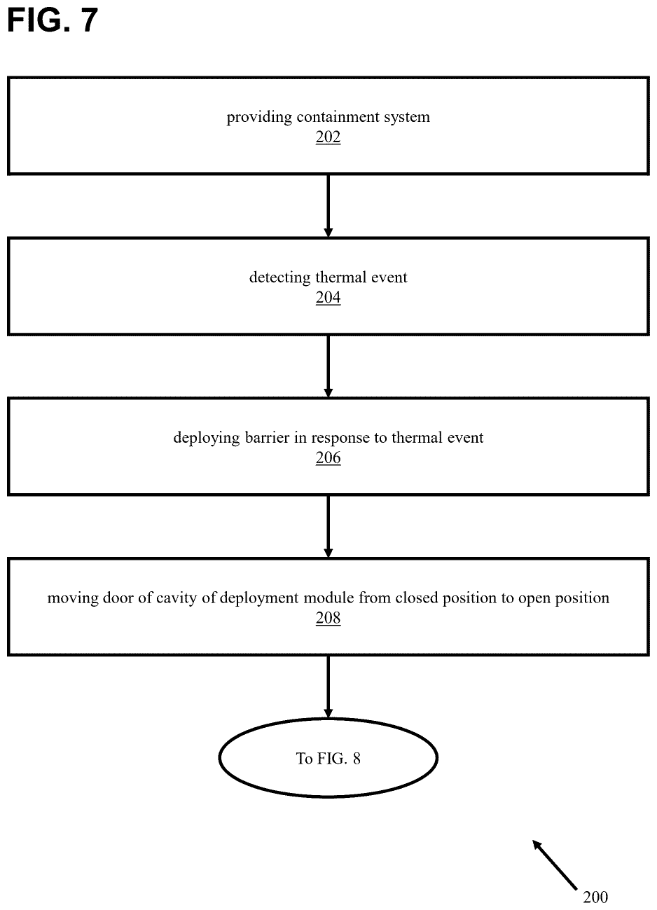

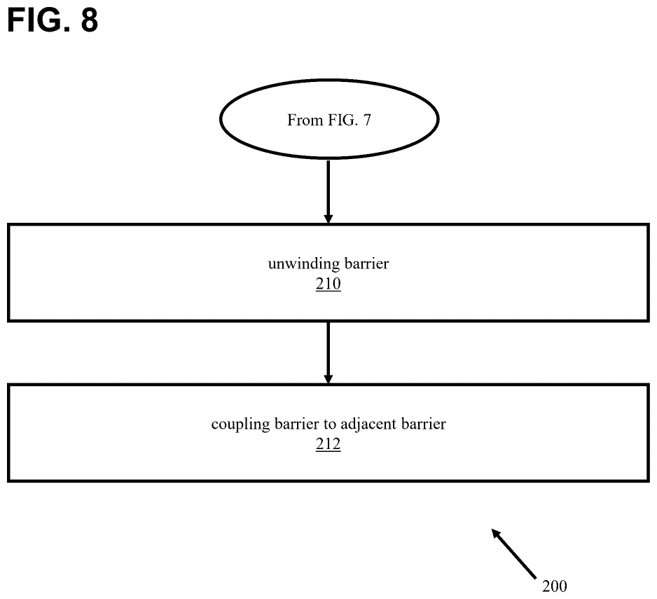

With reference to FIGS. 6-7, in certain embodiments, a method 200 of containing a vehicle 12 in a parking space 10 during a thermal event using containment system 100 is provided. The method 200 can include providing a containment system, which can include the containment system 100 as described herein. The method 200 can include detecting the thermal event using one or more sensors incorporated in the detection module 104. The sensor 120 can include a temperature sensor, a pressure sensor, a gas sensor, a smoke detector, a humidity sensor, or a tilt sensor, which can communicate conditions to the deployment module 102. Detection can be performed continuously or at intervals, with information interpreted by a controller 114 in the deployment module 102. Detection of the thermal event can trigger deploying the barrier 106.

Deploying the barrier can include moving a door 112 of a cavity 110 from a closed position to an open position. Opening the door 112 can allow the barrier 106 to begin deployment from a stored position within the cavity 110. The movement of the door 112 can be coordinated with the controller 114 to ensure smooth and timely release of the barrier 106.

The method 200 can include unwinding the barrier 106 from a reel assembly 116 after the door 112 has opened. The barrier 106 can transition from the first position to the second position. The unwinding can be monitored by the controller 114 to ensure that the barrier 106 reaches the intended deployed position.

Once the barrier is deployed, method 200 can include coupling the barrier 106 to an adjacent barrier 106 to form a contiguous enclosure. The coupling can include physical contact along edges of the respective barriers 106 and can be enhanced with magnetic elements. The magnetic coupling can improve stability, maintain alignment, and ensure a continuous perimeter to contain heat, smoke, or other effects associated with the thermal event.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A containment system for a parking space for a vehicle, comprising:
a deployment module configured to mount proximate to the parking space for the vehicle;
a detection module in communication with the deployment module, the detection module configured to detect a thermal event; and
a barrier operatively coupled to the deployment module, the barrier configured to deploy relative to at least a portion of the parking space for the vehicle in response to the detection module detecting the thermal event.

2. The containment system of claim 1, wherein the deployment module is configured to mount adjacent to the parking space, including on at least one side, above the parking space, or below a surface of the parking space.

3. The containment system of claim 1, wherein the deployment module includes a cavity, the barrier configured to deploy from the cavity.

4. The containment system of claim 3, wherein the cavity includes a door configured to move between an open position and a closed position.

5. The containment system of claim 4, wherein the deployment module includes a reel assembly configured to wind and unwind the barrier between a first position and a second position.

6. The containment system of claim 5, further comprising a motor configured to rotate the reel assembly.

7. The containment system of claim 6, wherein the cavity is comprised by a plurality of cavities.

8. The containment system of claim 1, wherein the detection module includes a sensor configured to detect the thermal event.

9. The containment system of claim 8, wherein the sensor includes a member selected from a group consisting of a temperature sensor, a pressure sensor, a gas sensor, a smoke detector, a humidity sensor, a tilt sensor, and combinations thereof.

10. The containment system of claim 1, wherein the barrier is configured to move between a first position and a second position when the detection module detects the thermal event.

11. The containment system of claim 1, wherein the barrier includes a temperature resistant material.

12. The containment system of claim 1, wherein the barrier includes a weighted material.

13. The containment system of claim 12, wherein the weighted material is disposed along a portion of the barrier configured to contact a surface of the parking space adjacent the vehicle when the barrier is in a deployed position.

14. The containment system of claim 13, wherein the barrier includes a first edge and a second edge disposed opposite each other, the first edge and the second edge being oriented substantially perpendicular to the surface of the parking space.

15. The containment system of claim 14, wherein each of the first edge and the second edge includes a magnetic element configured to couple with an adjacent barrier when deployed the barrier is in the deployed position.

16. The containment system of claim 1, wherein the portion of the parking space includes an entirety of the parking space.

17. The containment system of claim 1, wherein the containment system is installed proximate the parking space and the vehicle is disposed in the parking space.

18. A containment system for a parking space for a vehicle, comprising:
a deployment module configured to mount adjacent to the parking space for the vehicle;
a detection module in communication with the deployment module, the detection module configured to detect a thermal event; and
a barrier operatively coupled to the deployment module, the barrier configured to deploy in response to the detection module detecting a thermal event,
wherein:
the deployment module includes a mounting bracket configured to mount the deployment module adjacent to the parking space,
the deployment module includes a cavity, the barrier configured to deploy from the cavity,
the cavity includes a door configured to move between an open position and a closed position,
the deployment module includes an actuator configured to move the door from the open position to the closed position,
the deployment module includes a controller configured to be in communication with the detection module,
the deployment module includes a reel assembly configured to wind and unwind the barrier between a first position and a second position,
the first position is a stored and the second position is a deployed position,
the detection module includes a sensor configured to detect the thermal event,
the sensor includes a member selected from a group consisting of a temperature sensor, a pressure sensor, a gas sensor, a smoke detector, a humidity sensor, a tilt sensor, and combinations thereof,
the barrier includes a temperature resistant material, and
the barrier includes a weighted material.

19. A parking space for a vehicle, comprising:
the vehicle disposed in the parking space; and
a containment system installed above the parking space.

20. A method of containing a vehicle in a parking space during a thermal event, the method comprising:
providing the containment system of claim 1;
detecting the thermal event; and
deploying the barrier in response to the thermal event.
